(19) United States
(12) Patent Application Publication
(10) Pub. No.: US 2020/0391567 A1
(43) Pub. Date: Dec. 17, 2020

(54) Anti-Freeze Vehicle Air Suspension System

(71) Applicant: Gerald Robert Baker, Lodgepole (CA)

(72) Inventor: Gerald Robert Baker, Lodgepole (CA)

(21) Appl. No.: 16/443,318

(22) Filed: Jun. 17, 2019

(51) Int. Cl. B60G 17/0165; B60G 11/27; B60G 17/00; B60G 17/015

(52) U.S. Cl. CPC B60G 17/0165; B60G 11/27; B60G 2401/24; B60G 17/0155; B60G 2202/15; B60G 17/002

(57) ABSTRACT

A vehicle suspension system configured to utilize a compressed gas for operation of the vehicle suspension wherein the vehicle suspension system is operable in a first mode and a second mode. The vehicle suspension system includes a controller operably coupled to a compressor and a plurality of sensors. The compressor is coupled to a first input source and a second input source. The first input source is utilized in the first mode wherein the vehicle is in an environment that is above freezing. The second input source is utilized in an environment that is below freezing. An antifreeze introduction module is operably coupled to the second input source and is configured to provide introduction of an antifreeze compound into the second input source and subsequently the components of the vehicle suspension system. The vehicle suspension system further includes air springs, leveling valves being operably coupled by a network of lines.

### FIELD OF THE INVENTION

The present invention relates generally to vehicle suspension systems, more specifically but not by way of limitation, a vehicle air suspension system that is configured to resist problems caused by cold weather wherein the system of the present invention includes antifreeze compounds and lubricants in order to provide protection to the components of the system during extreme cold.

### BACKGROUND

As is known in the art, vehicle utilize various types of suspension systems wherein the suspension system are designed to optimize control of the vehicle and ride comfort. One vehicle suspension system that is popular is an air suspension. Air suspension replaces the typical mechanical leaf springs and coil springs with air bags that are manufactured from rubber and polyurethane. The air bags are operably coupled to an air compressor that is integrated into the vehicle. Standard settings of pressure for the air bags are set to mimic springs but unlike springs, the air bags can be adjusted to a pressure that is either lower or higher to provide a desired ride or function for the vehicle. Many luxury sedans will have air suspension so as to provide the vehicle with a soft ride on roads such as but not limited to highways. Another vehicle application for air bags are pickup trucks. Pickup trucks commonly utilize air bags for at least two reasons. First, the air bags can be utilized to improve the ride quality of the pickup truck during normal operating conditions. Alternatively, when either hauling a heavy trailer or when a large load is placed in the bed of the pickup truck, the air bags can be used to provide leveling and stabilization of the pickup truck which improves the control thereof.

While the conventional air bag systems do provide benefits, as mentioned herein above, these suspension system are known to experience problems when operating in cold environments. As air has a certain amount of moisture, freezing climates and extreme cold will result in the freezing of the moisture disposed within the air bag suspension system. When the moisture in the air bag suspension system freezes it typically results in various component failures. By way of example but not limitation, the valves in the air bag suspension systems can become clogged and inoperable due to frozen moisture particles. The freezing of valves can cause the compressor to function improperly which results in additional problems and/or failure of the compressor.

Accordingly, there is a need for an air bag suspension system for pickup trucks and similar vehicles wherein the air bag suspension system further includes the ability to inject anti-freeze compounds and lubricants into the system upon detection of sub-freezing temperatures in order to inhibit failure of the air bag suspension system during freezing temperatures.

### SUMMARY OF THE INVENTION

It is the object of the present invention to provide an air bag suspension system that is configured to accommodate freezing temperatures wherein the air bag system of the present invention provides introduction of an anti-freezing compound to inhibit freezing of the components of the air bag suspension system.

Another object of the present invention is to provide an air suspension system for a vehicle wherein the air suspension system is configured to introduce an antifreeze compound wherein the antifreeze compound can be introduced utilizing alternate techniques.

A further object of the present invention is to provide an air bag suspension system that is configured to accommodate freezing temperatures wherein the air bag system of the present invention that can include addition of the antifreeze compound into the air intake line prior to an air filter.

Still another object of the present invention is to provide an air suspension system for a vehicle wherein the air suspension system is configured to introduce an antifreeze compound wherein the antifreeze compound can be saturated into the air filter so as to evaporate into the airstream being introduced into the lines and air bags.

An additional object of the present invention is to provide an air bag suspension system that is configured to accommodate freezing temperatures wherein the air bag system of the present invention wherein the antifreeze compound can be introduced into the system during the charging thereof.

Yet a further object of the present invention is to provide an air suspension system for a vehicle wherein the air suspension system is configured to introduce an antifreeze compound so as to inhibit damage thereto during freezing temperatures that further includes leveling valves upstream of each air bag proximate the wheels of the vehicle.

Another object of the present invention is to a provide an air bag suspension system that is configured to accommodate freezing temperatures wherein the air bag system of the present invention wherein one embodiment can utilize a saturated element that provides introduction of the antifreeze compound into the air bag suspension system.

An alternate object of the present invention is to provide an air suspension system for a vehicle wherein the air suspension system is configured to introduce an antifreeze compound so as to inhibit damage thereto during freezing temperatures wherein the compressor can further include a reservoir of antifreeze compound so as to provide introduction thereof into the air bag suspension system of the present invention.

Still a further object of the present invention is to provide an air bag suspension system that is configured to accommodate freezing temperatures wherein the air bag system of the present invention that further includes a temperature sensor operable to detect freezing temperatures and provide a signal to introduce an antifreeze compound into the system.

An additional object of the present invention is to provide an air suspension system for a vehicle wherein the air suspension system is configured to introduce an antifreeze compound so as to inhibit damage thereto during freezing temperatures wherein the present invention further includes a controller providing operation of the present invention.

To the accomplishment of the above and related objects the present invention may be embodied in the form illustrated in the accompanying drawings. Attention is called to the fact that the drawings are illustrative only. Variations are contemplated as being a part of the present invention, limited only by the scope of the claims.

### BRIEF DESCRIPTION OF THE DRAWINGS

A more complete understanding of the present invention may be had by reference to the following Detailed Description and appended claims when taken in conjunction with the accompanying Drawings wherein:

FIG. 1 is a diagrammatic view of an exemplary embodiment of the present invention.

### DETAILED DESCRIPTION

Referring now to the drawings submitted herewith, wherein various elements depicted therein are not necessarily drawn to scale and wherein through the views and figures like elements are referenced with identical reference numerals, there is illustrated a vehicle air suspension system 100 constructed according to the principles of the present invention.

An embodiment of the present invention is discussed herein with reference to the figures submitted herewith. Those skilled in the art will understand that the detailed description herein with respect to these figures is for explanatory purposes and that it is contemplated within the scope of the present invention that alternative embodiments are plausible. By way of example but not by way of limitation, those having skill in the art in light of the present teachings of the present invention will recognize a plurality of alternate and suitable approaches dependent upon the needs of the particular application to implement the functionality of any given detail described herein, beyond that of the particular implementation choices in the embodiment described herein. Various modifications and embodiments are within the scope of the present invention.

It is to be further understood that the present invention is not limited to the particular methodology, materials, uses and applications described herein, as these may vary. Furthermore, it is also to be understood that the terminology used herein is used for the purpose of describing particular embodiments only, and is not intended to limit the scope of the present invention. It must be noted that as used herein and in the claims, the singular forms “a”, “an” and “the” include the plural reference unless the context clearly dictates otherwise. Thus, for example, a reference to “an element” is a reference to one or more elements and includes equivalents thereof known to those skilled in the art. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

References to “one embodiment”, “an embodiment”, “exemplary embodiments”, and the like may indicate that the embodiment(s) of the invention so described may include a particular feature, structure or characteristic, but not every embodiment necessarily includes the particular feature, structure or characteristic.

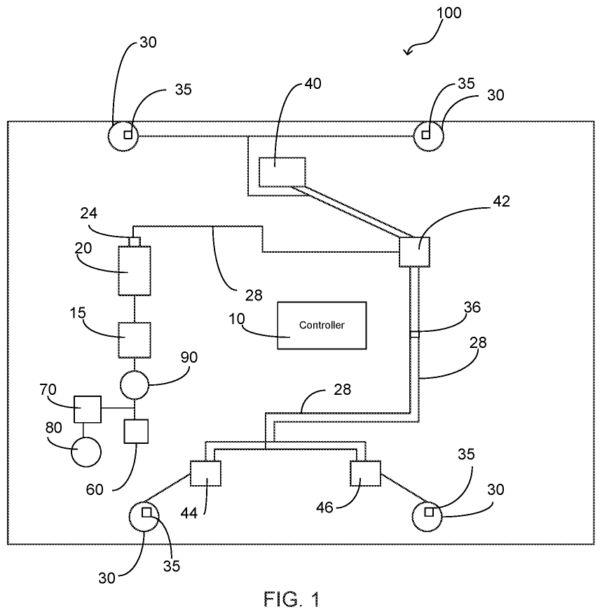

Now referring in particular to the FIG. 1 submitted herewith, the vehicle air suspension system 100 includes a controller 10. The controller 10 provides operation and functional control of the vehicle air suspension system 100. While not particularly illustrated herein, it should be understood within the scope of the present invention that the controller 10 is operably coupled to an interface that would be disposed within the passenger compartment of the vehicle in which the vehicle air suspension system 100 is mounted. This interface would provide conventional settings such as inflation and deflation of one or more of the air springs 5 and further facilitate user inputs for the functionality as is further described herein. The controller 10 includes the necessary electronics to receive, store, transmit and manipulate data. The controller 10 is operably coupled to the vehicle power supply(not illustrated herein) in order to provide power for operation thereof. The controller 10 further provides a first operational mode and a second operational mode for the vehicle air suspension system 100. In the first operational mode, the controller 10 provides proper operation of the vehicle air suspension system 100 in temperatures that are greater than forty degrees Fahrenheit. In the second operational mode, the controller 10 provides proper operation of the vehicle air suspension system 100 in temperatures that are less than forty degrees Fahrenheit. As will be further discussed herein, the second operational mode of the vehicle air suspension system 100 inhibits damage to the components of the vehicle air suspension system 100 that can be caused by freezing temperatures. It should be understood within the scope of the present invention that the aforementioned forty degrees is for reference purposes only and the intention is to distinguish between near or below freezing temperatures with temperatures several degrees above freezing.

The controller 10 is operably coupled to compressor 15. The compressor 15 is a conventional compressor that is operable to provide for distribution a gas such as but not limited to air or nitrogen wherein the gas is provided at a pressure that is greater than that of atmospheric pressure. The compressed gas is provided to an accumulator tank 20, which stores a sufficient volume of gas that is required to provide operation of the vehicle air suspension system 100. The accumulator tank 20 is manufactured from a suitable durable material such as but not limited to metal and is manufactured in alternate sizes and shapes so as to accommodate being mounted to various vehicles and further provide required gas volumes for sufficient operation of the vehicle air suspension system 100. The compressor 10 is pneumatically coupled to the accumulator tank 20 and sensor 21 disposed therein measures and transmits the pressure within the accumulator tank 20. Ensuing the accumulator tank 20 reaching a pressure below the programmed threshold, the compressor 15 will provide additional compressed gas thereinto. A relief valve 24 is present on the accumulator tank 20 and is a conventional valve that functions to provide release of an overpressure or if the accumulator tank 20 is desired to be evacuated of the compressed gas. As will be further discussed herein, the gas intake source will vary depending upon the mode of operation of the vehicle air suspension system 100. While an accumulator tank 20 is illustrated and discussed herein, it is contemplated within the scope of the present invention that the vehicle air suspension system 100 could be configured without an accumulator tank 20. This alternate configuration is further discussed herein.

The accumulator tank 20 is fluidly coupled to the air springs 30 utilizing lines 28. Lines 28 are conventional compressed gas lines manufactured from a suitable durable material and are configured in a network so as to distribute the compressed gas to the air springs 30. It should be understood within the scope of the present invention that the lines 28 could be configured in various manners in order to achieve the desired objective as described herein. The lines 28 terminate at each of the air springs 30. As is known in the art, the air springs are operably coupled to the frame of a vehicle adjacent each tire. The air springs 30 of the present invention are conventional air springs manufactured from rubber and/or polyurethane and have an interior volume configured to receive compressed gas therein. The air springs 30 are adjustable utilizing compressed gas from the compressor 15 and are adjusted to accommodate the required driving requirement for the operator of the vehicle in which the vehicle air suspension system 100 is installed.

Disposed in each air spring 30 are sensors 35. The sensors 35 are operably coupled to the controller 10 utilizing suitable techniques. The sensors 35 are configured to provide measurement of three parameters and transmit the measurement data to the controller 10. The first data parameter is gas pressure. During adjustment of the air springs 30 for a desired application the pressure of the air spring 30 is transmitted to the controller 10 and inflation/deflation thereof is suspended once the required pressure is achieved. The second data parameter measured by the sensors 35 is the relative humidity of the gas disposed within the air springs 30. Lastly, the sensors 35 further provide temperature data to the controller 10. The temperature data and relative humidity data are analyzed by the controller 10 to determine if the vehicle air suspension system 100 is operated in either the first mode or second mode as further discussed herein. An additional sensor 36 is disposed in line 28 and provides identical information as the aforementioned for temperature and humidity. It should be understood by those skilled in the art that the vehicle air suspension system 100 could employ various quantities of sensors 35 and further be located at alternate points within the vehicle air suspension system 100 in order to provide the desired data.

The vehicle air suspension system 100 further includes leveling valves 40,42,44,46. The leveling valves 40,42,44,46 are conventional gas valves that are operably coupled to the lines 28 and controller 10. The leveling valves 40,42,44,46 provide adjustment of gas pressure to the required air springs 30 in order to provide both lateral and longitudinal leveling of the vehicle in which the vehicle air suspension system 100 is installed. It is contemplated within the scope of the present invention that the vehicle air suspension system 100 could employ as few as one leveling valve or more than two.

The vehicle air suspension system 100 includes a first input source 60 and a second input source 70. The vehicle air suspension system 100 will employ either the first input source 60 or second input source 70 dependent upon the mode of operation of the vehicle air suspension system 100. In the first mode of operation of the vehicle air suspension system 100, the first input source 60 is utilized. In the first mode of operation, the vehicle in which the vehicle air suspension system 100 is installed is located in an environment that has a temperature that is greater than forty degrees. The controller 10 receives temperature data from the sensors 35 and determines the mode of operation. When the temperature data from the sensors 35 is greater than forty degrees than the controller 10 places the vehicle air suspension system 100 in the first mode. In the first mode of operation the first input source 60 is utilized for intake of additional gas to be introduced into the vehicle air suspension system 100. The first input source 60 can be configured in alternate techniques. It is contemplated within the scope of the present invention that the first input source 60 could be a conventional air intake valve wherein atmospheric air is introduced into the vehicle air suspension system 100 for compression and distribution thereof when the vehicle air suspension system 100 requires an additional volume of gas for operation. Alternatively, the first input source 60 could be configured as an air tank constructed of suitable materials that is charged with a source of compress gas such as but not limited to air or nitrogen. In the latter, the tank is charged utilized suitable techniques and supplies a volume of gas to the compressor for pressurizing and distribution into the vehicle air suspension system 100. The first mode of operation utilizing the first input source 60 occurs when temperatures are above freezing. During temperatures that are above freezing, any moisture present in the air will not damage the components of the vehicle air suspension system 100. Normal operation of the vehicle air suspension system 100 can occur in non-freezing temperatures thus allowing use of atmospheric air for the first operational mode of the vehicle air suspension system 100

When a vehicle having the vehicle air suspension system 100 is exposed to freezing climates, the controller 10 will transition the vehicle air suspension system 100 to its second operational mode. The second operational mode is operable to inhibit damage to the components of the vehicle air suspension system 100 due to freezing of the moisture present within the gas disposed within the vehicle air suspension system 100. The freezing of the moisture causes failures of components such as but not limited to the compressor 10, and the valve 24 and leveling valves 40,42. In the second mode of operation the second input source 70 is utilized to introduce additional gas when required for operation of the vehicle air suspension system 100. The second input source 70 can be either a conventional intake valve that is operable to receive therein atmospheric air or a tank having a gas such as but not limited to nitrogen disposed therein.

The second input source 70 has operably coupled thereto an antifreeze introduction module 80. The antifreeze introduction module 80 provides introduction of a material, such as but not limited to alcohol, into the second input source 70 for distribution thereof in conjunction with the gas. It is contemplated within the scope of the present invention that the antifreeze introduction module 80 could be constructed in alternate configurations. By way of example but not limitation, the antifreeze introduction module 80 could be configured as a small tank having an antifreeze solution disposed therein wherein a portion of the solution is introduced into the second input source 70 for further distribution thereof. Alternatively, it is contemplated within the scope of the present invention that the antifreeze introduction module 80 could be filter saturated with an antifreeze solution wherein the antifreeze solution evaporates into the second input source 70 providing introduction of the gas and antifreeze mixture into the vehicle air suspension system 100 in the second mode thereof. In the latter configuration, the filter is a serviceable item that can be either replaced or re-saturated with a desired antifreeze solution.

A filter 90 is present and is operably intermediate the first input source 60, second input source 70 and compressor 15. The filter 90 is a conventional particulate filter and is operable to provide filtration of the gas being introduced into the vehicle air suspension system 100 from either the first input source 60 and second input source 70.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical changes may be made without departing from the spirit or scope of the invention. The description may omit certain information known to those skilled in the art. The preceding description is, therefore, not intended to be limited to the specific forms set forth herein, but on the contrary, it is intended to cover such alternatives, modifications, and equivalents, as can be reasonably included within the spirit and scope of the invention.

What is claimed is:

1. A vehicle suspension system that utilizes a compressed gas comprising:
a controller, said controller having the necessary electronics to receive, store, transmit and manipulate data, said controller configured to provide operation of the vehicle suspension system,
a compressor, said compressor being configured to provide compressed gas to the vehicle suspension system, said compressor operably coupled to a plurality of lines wherein said plurality of lines are operable to distribute compressed gas generated by said compressor;
at least one air spring, said at least one air spring having an interior volume configured to receive the compressed gas therein from one of said plurality of lines, said at least one air spring being adjustable;
a first input source, wherein said first input source is operably coupled to said compressor, said first input source configured to provide introduction of a gas into said compressor;
a second input source, wherein said second input source is operably coupled to said compressor, said second input source being configured to provide a gas to said compressor; and
wherein said second input source is utilized in a second mode of the vehicle suspension system and the first input source is utilized in a first mode of the vehicle suspension system.

2. The vehicle suspension system as recited in claim 1, and further including an antifreeze introduction module, said antifreeze introduction module being operably coupled to said second input source, said antifreeze introduction module configured to provide introduction of an antifreeze compound into said second input source.

3. The vehicle suspension system as recited in claim 2, and further including a plurality of sensors, said plurality of sensors operable to provide temperature and humidity data readings to said controller.

4. The vehicle suspension system as recited in claim 3, wherein the vehicle suspension system is operable in the first mode upon being present in an environment having a temperature that is above freezing.

5. The vehicle suspension system as recited in claim 4, wherein the vehicle suspension system is operable in the second mode upon being present in an environment having a temperature that is at or below freezing.

6. The vehicle suspension system as recited in claim 5, and further including an accumulator tank, said accumulator tank being operably coupled to said compressor, said accumulator tank configured to receive an retain a volume of compressed gas for use by the vehicle suspension system.

7. The vehicle suspension system as recited in claim 6, wherein said controller provides operational transfer intermediate said first mode and said second mode of the vehicle transfer system.

8. A vehicle suspension system installed in a vehicle that utilizes a compressed gas wherein the vehicle suspension system includes a first operational mode and a second operational mode comprising:
a controller, said controller being mounted on the vehicle, said controller having the necessary electronics to receive, store, transmit and manipulate data, said controller configured to provide operation of the first operational mode and second operational mode of the vehicle suspension system,
a compressor, said compressor being configured to provide compressed gas to the vehicle suspension system, said compressor operably coupled to a plurality of lines wherein said plurality of lines are operable to distribute compressed gas generated by said compressor;
a plurality of air springs, said plurality of air springs having an interior volume configured to receive the compressed gas therein from one of said plurality of lines, said plurality of air springs being adjustable in pressure in order to adjust a suspension component of the vehicle;
a first input source, wherein said first input source is operably coupled to said compressor, said first input source configured to provide introduction of a gas into said compressor, said first input source being utilized in said first operational mode;
a second input source, wherein said second input source is operably coupled to said compressor, said second input source being configured to provide a gas to said compressor said second input source being utilized in said second operational mode;
an antifreeze introduction module, said antifreeze introduction module being operably coupled to said second input source, said antifreeze introduction module configured to disperse an antifreeze compound into said second input source.

9. The vehicle suspension system as recited in claim 8, wherein said first input source is configured to introduce one of the following gases into the compressor: air or nitrogen.

10. The vehicle suspension system as recited in claim 9, and further including a plurality of sensors, said plurality of sensors configured to provide gas pressure, temperature and humidity data proximate to each of said plurality of sensors, said plurality of sensors distributed within the vehicle suspension system.

11. The vehicle suspension system as recited in claim 10, wherein in said first operational mode, said controller has received at least one temperature reading from one of said plurality of sensors wherein the at least one temperature reading is above freezing.

12. The vehicle suspension system as recited in claim 11, and further including a filter, said filter being intermediate said compressor and said first input source and said second input source, said filter configured to provide filtration of gas being introduced into said compressor.

13. The vehicle suspension system as recited in claim 12, wherein in said second operational mode, said controller has received at least one temperature reading from one of said plurality of sensors wherein the at least one temperature reading is at or below freezing.

14. The vehicle suspension system as recited in claim 13, wherein the antifreeze introduction module is formed from a group consisting of one of the following: a saturated element or a storage tank.

15. A vehicle suspension system installed in a vehicle that utilizes a compressed gas wherein the vehicle suspension system includes a first operational mode and a second operational mode wherein the second operational mode is activated upon the vehicle being present in an environment having a temperature that is at or below freezing wherein the vehicle suspension system comprises:
a controller, said controller being mounted on the vehicle, said controller having the necessary electronics to receive, store, transmit and manipulate data, said controller configured to provide operation of the first operational mode and second operational mode of the vehicle suspension system,
a compressor, said compressor being configured to provide compressed gas to the vehicle suspension system, said compressor operably coupled to a plurality of lines wherein said plurality of lines are operable to distribute compressed gas generated by said compressor;
a plurality of air springs, said plurality of air springs having an interior volume configured to receive the compressed gas therein from one of said plurality of lines, said plurality of air springs being adjustable in pressure in order to adjust a suspension component of the vehicle;
a plurality of sensors, said plurality of sensors configured to provide gas pressure, temperature and humidity data proximate to each of said plurality of sensors, said plurality of sensors distributed within the vehicle suspension system;
a first input source, wherein said first input source is operably coupled to said compressor, said first input source configured to provide introduction of a gas into said compressor, said first input source being utilized in said first operational mode, wherein in said first operational mode the vehicle is in an environment that has a temperature that is above freezing;
a second input source, wherein said second input source is operably coupled to said compressor, said second input source being configured to provide a gas to said compressor said second input source being utilized in said second operational mode, wherein in said second operational mode the vehicle is in an environment that has a temperature that is at or below freezing;
an antifreeze introduction module, said antifreeze introduction module being operably coupled to said second input source, said antifreeze introduction module configured to disperse an antifreeze compound into said second input source.

16. The vehicle suspension system as recited in claim 15, wherein the antifreeze introduction module is formed from a group consisting of one of the following: a saturated element or a storage tank.

17. The vehicle suspension system as recited in claim 16, and further including a filter, said filter being intermediate said compressor and said first input source and said second input source, said filter configured to provide filtration of gas being introduced into said compressor.

18. The vehicle suspension system as recited in claim 17, and further including an accumulator tank, said accumulator tank being operably coupled to said compressor, said accumulator tank configured to store a volume of compressed gas for the vehicle suspension system.

19. The vehicle suspension system as recited in claim 19, wherein the antifreeze compound is alcohol.
